(19) United States
(12) Patent Application Publication
(10) Pub. No.: US 2004/0155109 A1
(43) Pub. Date: Aug. 12, 2004

(54) Digital assistant for use in a commercial environment

(75) Inventors: William M. Kenney, Glen Ellyn, IL (US); Douglas Alex Stone, Chicago, IL (US); Jessica Christine Downs, Chicago, IL (US)

Correspondence Address: MICHAEL BEST & FRIEDRICH, LLP, 100 E WISCONSIN AVENUE, MILWAUKEE, WI, 53202, US

(73) Assignee: Sears Brands, LLC

(21) Appl. No.: 10/365,581

(22) Filed: Feb. 12, 2003

(51) Int. Cl. G06K 7/10; G06K 9/22

(52) U.S. Cl. 235/462.45

(57) ABSTRACT

A method and apparatus for generating, in a commercial environment, alternative or complementary suggestions in response to a specific inquiry about a product, for displaying the suggestions on a display device at the point of purchase, and for providing real time electronic communication with a product expert.

### BACKGROUND OF THE INVENTION

1. Technical Field

The invention relates to wireless communication devices, and more particularly to such a device for use in retail sales.

2. Background Information

The use of digital information devices in the retail environment to provide a customer with product data is known. Many devices provide a bar code scanner such that a customer may scan the bar code of a selected product and then be presented with information corresponding to the product.

U.S. Pat. No. 5,361,871 discloses a portable product information unit that allows a user to scan items using a barcode scanner to obtain product information. The product information is stored in the unit and can be updated periodically to reflect changes in product information (e.g., price, name, etc.). The unit may also store a list of products scanned by the user such that the user can compare prices charged at the checkout with prices scanned in the aisles.

U.S. Pat. No. 5,457,307 discloses a purchase monitoring device. The device allows the user to scan items the user wishes to purchase while the user is shopping. A running total is kept that provides the user with information regarding the amount they have currently spent. Items can be removed from the running total if the user decides to not purchase the item.

### SUMMARY OF THE INVENTION

Among the issues presented by retail sales of goods and services are the increased sophistication of the products, the increased rate of change in products and difficulties on the part of consumers to make informed purchasing decisions in the face of the increased selection of available products. In short, consumers face an increasingly confusing marketplace for many goods and services. Accordingly, as goods and services proliferate and customer confusion increases, the retailer must introduce the new products into the marketplace quickly, at low cost and in a manner that does not cause further confusion.

For the same reasons, retailers face increasing challenges in maintaining a fully informed sales force. Sales associates seeking to assist consumers in making purchasing decisions should be informed as to the choices available to the consumer and as to the ramifications of those decisions in order to be helpful, to develop and maintain credibility with the customer, and to develop and maintain customer loyalty. These objectives are made more difficult in an environment wherein there is frequent turnover in the employment of sales associates, and limited time to train sales associates in increasingly complex technical subjects. Accordingly, it is desirable to increase the personal effectiveness of the sales associate and maximize the earning power of the sales associate to assist in the retention of the sales associate.

In view of the foregoing, the invention provides an apparatus and method that assists the sales associate in personal effectiveness and the customer in making purchasing decisions. The invention, by providing such assistance, promotes consumers' trust in the sales associate, enables the retailer to offer an increased array of products and services, helps strengthen customer recognition of the retailer and helps develop supplier/business partner relationships.

In one embodiment, the invention provides a hand-held, portable, electronic, wireless communications device that is internet-based and that includes a data input device, such as a bar code scanner or scanning pen. The invention also provides a database in communication with the device and containing a body of organized information. The device and related database are used by a sales associate in multiple ways. In engaging the customer as to the interests of the consumer, the sales associate will be prompted by the device to inquire as to the activities the consumer expects to engage in with the product/service in which the consumer is interested. The device and database provide a variety of information in various formats to assist the sales associate in guiding the customer through the purchasing decision process.

In one embodiment, the invention provides just-in-time information support to the sales associate. The just-in-time information sales support can be tailored for a particular department and/or function. Also, the system provides productivity tools to the sales associate that have heretofore been unavailable to the sales associate. The system also makes available sales associates who have become experts in their respective fields available by way of e-mail and/or video conferencing facilities to consult on an as needed, real time basis with colleagues and customers.

In one embodiment, the database provides a “lifestyle barometer” which utilizes input from the sales associate to provide options and recommendations to the sales associate meeting the input criteria. The consumer also has the ability, when presented with the options, to expand or contract product recommendations, thus providing the customer with a sense of control and contribution to the decision-making process. Similarly, in the event the customer does not respond favorably to a set of product recommendations, the sales associate can offer customization to the customer's expressed needs, or offer alternative product suggestions, or products that are complementary to the desired product.

With respect to the customer, the invention provides advantage by demonstrating to the customer the availability of organizational knowledge without regard to the specific sales associate's expertise.

In one embodiment, the invention provides for the creation of consumer profiles based on compiled personal and purchasing information, and with the use of the consumer profile to complete warranty registration. This feature tends to increase the customer's sense that the retailer will have reliable records relating to the consumer's purchases. Also, accessories, features, compatibility, pricing, availability and other product characteristics will be immediately available to the consumer and sales associate in the form of pop-up icons or scripts made available from the database based on the inputs of the customer and the sales associate. This feature ensures that the customer's confusion is eliminated, and tends to reduce the cost of the sale by making the purchasing decision more streamlined.

In another embodiment, the system produces a written record of the purchase. This record can be made to be compatible with a point of sale register so that the customer can pay for the purchase after completing the purchase with the sales associate. Also, the record can include identifying information enabling the customer to track delivery or access other transactional information through a call center or a web site.

As to the retailer, the advantages of the invention include a training function. Sales associates can use the system while on the job to gain familiarity with the products offered by the retailer, thereby eliminating the need for merchandise list books and other materials that can easily become out-of-date. Also, with on-line comparison of products and product features available while in a face-to-face contact with a sales associate who can present the information within relevant decision points, the benefits of on-line shopping and in-store shopping are both achieved.

Further as to benefits achieved from the retailer's perspective, the purchase/sale information can be readily and accurately presented to suppliers/vendors, and specific supplier/business partner information can be consistently and accurately displayed to the consumer.

In its various embodiments the invention provides one or more of the following useful benefits. The invention may provide the sales associate with a tool to help the sales associate to succeed in the commercial environment; may decrease the costs of servicing customers without “off loading” activities to the customer; may help provide information to the sales associate and the customer so that the customer is assured and confident in making the purchasing decision; may help correlate on-line and in-person sales/purchasing experiences; may provide sales/purchasing information to the retailer and the retailer's supplier/business partners; and may provide an information technology that can be used in self-help environments in order to maximize the return on investment in the sales associate assistance system.

Other features and advantages of the invention will become apparent to those skilled in the art upon review of the following detailed description, claims and drawings.

### BRIEF DESCRIPTION OF THE DRAWINGS

FIG. 1 is a perspective view of a hand-held digital assistant embodying the present invention.

FIG. 2 is a schematic of a database structure by the digital assistant shown in FIG. 1.

FIG. 3 is a schematic of a portion of the database structure of FIG. 2.

FIG. 4 is a schematic of a portion of the database structure of FIG. 2.

FIG. 5 is a view of a product offering list displayed by the digital assistant of FIG. 1.

FIG. 6 illustrates a questionnaire screen displayed by the digital assistant of FIG. 1.

FIG. 7 illustrates a product customization screen displayed by the digital assistant of FIG. 1.

FIG. 8 illustrates a product specification screen displayed by the digital assistant of FIG. 1.

FIG. 9 illustrates a related product selection screen displayed by the digital assistant of FIG. 1.

FIG. 10 illustrates a final upsell screen displayed by the digital assistant of FIG. 1.

FIG. 11 illustrates a work order that is generated by the digital assistant of FIG. 1.

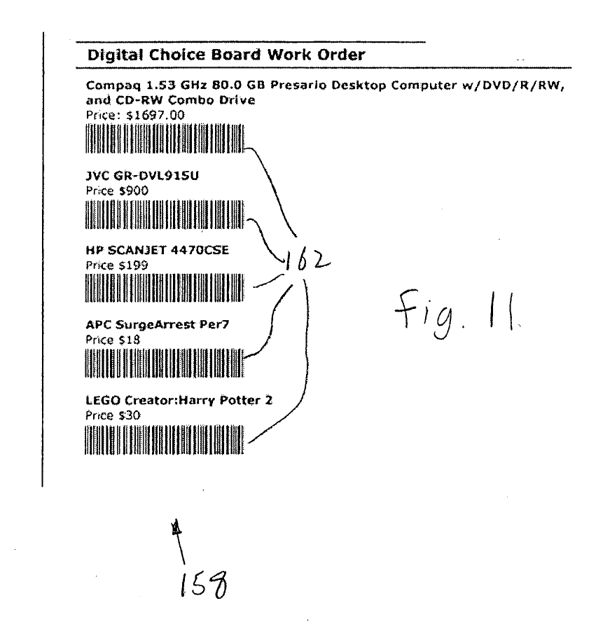

Before one embodiment of the invention is explained in detail, it is to be understood that the invention is not limited in its application to the details of construction and the arrangements of the components set forth in the following description or illustrated in the drawings. The invention is capable of other embodiments and of being practiced or being carried out in various ways. Also, it is understood that the phraseology and terminology used herein is for the purpose of description and should not be regarded as limiting. The use of “including” and “comprising” and variations thereof herein is meant to encompass the items listed thereafter and equivalents thereof as well as additional items.

### DETAILED DESCRIPTION OF THE PREFERRED EMBODIMENT

The drawings illustrate a method and apparatus for assisting a sales associate in the presentation and selection of products and services to a customer in a commercial environment. As used herein, “commercial environment” means the retail sales environment as well as the field sales environment. For example, a service technician at the home of a customer for a repair might use the illustrated method and apparatus to assist a customer in a similar way that a sales associate in a retail store would use the method and apparatus to assist a customer. The illustrated method and apparatus may also be used directly by a customer either in the retail store or remote from the store to assist them in the selection of products and services in a commercial environment.

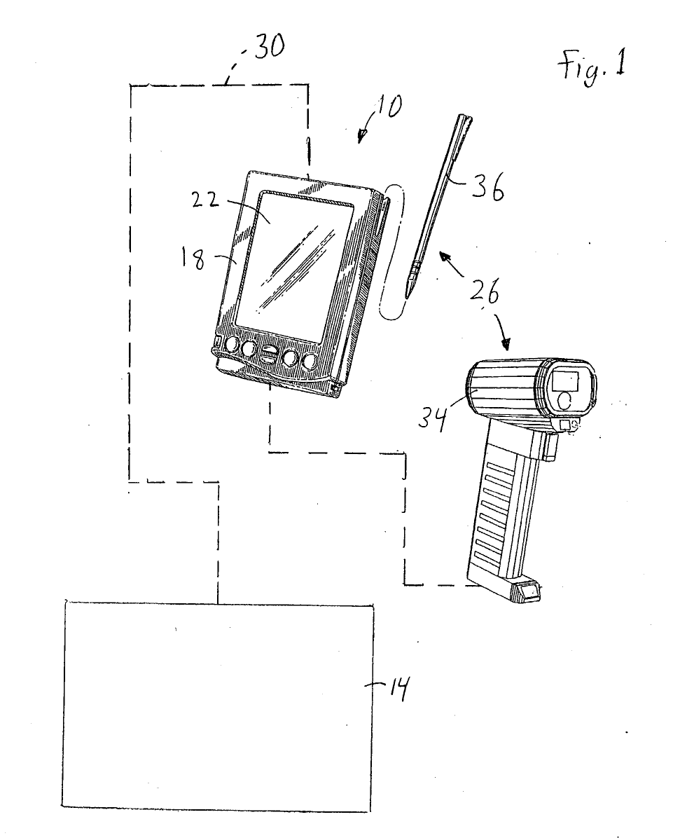

In one embodiment, as illustrated in FIG. 1, the apparatus comprises a hand-held, portable, electronic device 10 that communicates with a central database 14 that includes, among other things, information relating to products and services offered by a retail store. The device 10 may also be an in-store kiosk, accessible by the customer and/or the sales associate, a personal computer, a personal digital assistant, or other wireless personal devices.

The device 10 includes a housing 18, a display 22, a speaker (not shown), an input interface 26, and a communication link 30 that communicates with the central database 14. The device 10 may communicate with the central database 14 via the internet, by wireless link, or by docking the device 10 with a personal computer for wired access.

The illustrated device 10 is hand-held and wireless such that a sales associate may carry the device substantially anywhere within a retail environment as required. Alternatively, kiosks may be strategically placed within the retail environment for ease of access by a sales associate and/or a customer. The housing 18 surrounds and supports the display 22, the speaker and the input interface 26. The display 22 is any display suitable for either text or graphics, or both.

As illustrated in FIG. 1, the input interface 26 comprises an attached hand-held product scanner 34 that communicates with the device 10. However, the input interface 26 could also be integrated with the device 10. The input interface 26 may also comprise a touch-screen, which may be the same as the display 22, that is operated either by manual touching of the screen or using a light pen or “stylus” as is known in the art. The scanner 34 may communicate with the device through wireless methods (e.g. infrared waves) or via a conventional wire. The input interface 26 may further comprise a voice recognition system that receives and interprets vocal commands. The input interface 26 is configured to receive various formats and types of information, which the device 10 then communicates to the central database 14 for processing.

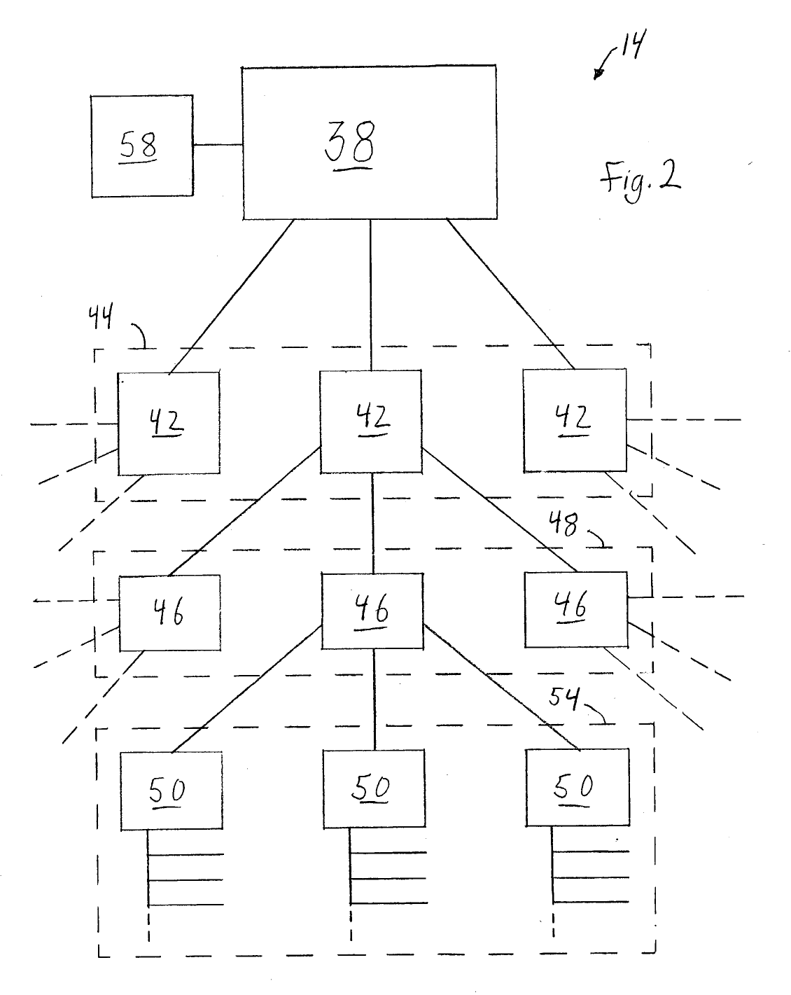

Referring now to FIG. 2, the central database 14 includes information about available products and services. In general, the database 14 is configured and arranged similarly to a retail store so as to provide an intuitive and familiar organization of information to a user. To that end, the database 14 includes various “departments” or levels that correspond to those of a physical retail store. The database 14 includes a first level 38 that represents the entire retail store and includes substantially every other level of the database including levels related to specific products and services. The retail store level 38 is divided into multiple retail areas 42, which further comprise a second level 44 of the database 14. Examples of possible retail areas 42 include, among other things, home audio/video, computers, home furnishings, and appliances. Of course the specific retail areas 42 that are established within the database 14 will depend upon the actual retail store the database 14 is configured to resemble.

Products and services in the database 14 are further grouped into product categories 46 and service categories (not shown), which comprise a third level 48 of the database. While only product categories 46 are illustrated and discussed further below, it should be appreciated that the organization and configuration of service categories is similar to the organization and configuration of product categories 46 in most respects. Without limitation, examples of product categories 46 that may appear within the home audio/video retail area 42 discussed above include, among other things, televisions, VCRs, speakers, receivers, and CD players. Within each product category 46 is a plurality of specific products 50 that comprises a fourth level 54 of the database. Each specific product entry includes product-related information that is specific to the product. Such product related information might, for example, include product specifications, product cost, product inventory, and other product factors including overall product performance ratings and the like. The specific product entry may be configured to include substantially any information that a customer may need or desire in order to make an informed buying decision.

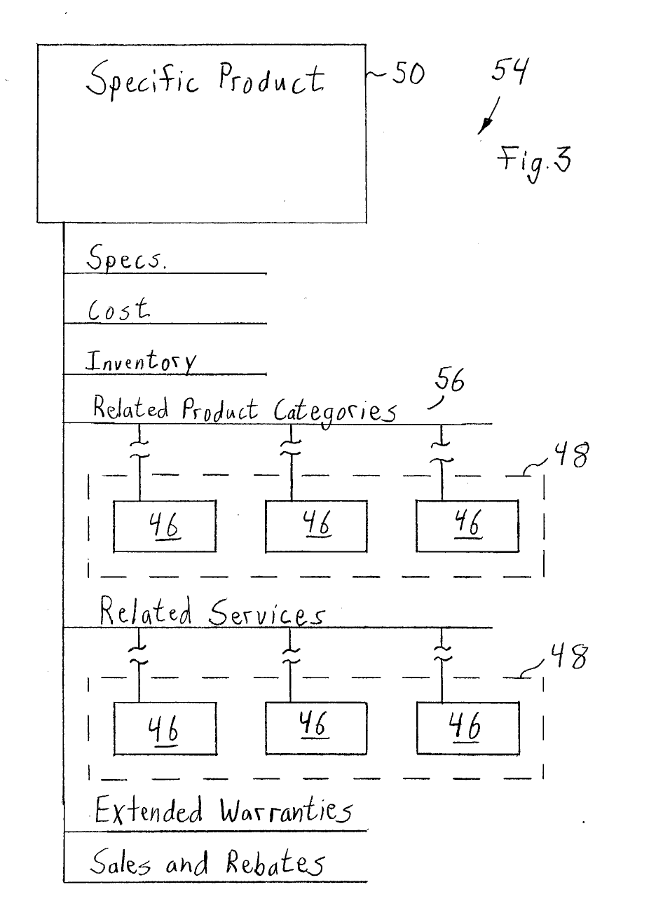

Referring also to FIG. 3, the specific product entry includes a related product categories field 56 that is configured to link specific products 50 with related product categories 46 from the third level 48 of the database 14. Similarly, specific products 50 are also linked with related service categories, which are also located on the third level 48 of the database. For example, selection of a specific television may link a user to various television programming services such as cable service providers and satellite service providers. Also, a specific product 50 entry may include information about available extended warranties, maintenance plans, or sale and rebate information as appropriate. The database 14 is configured to serve as a facility for storing and organizing substantially all information related to the sale and support of substantially any product or service offered in a retail store.

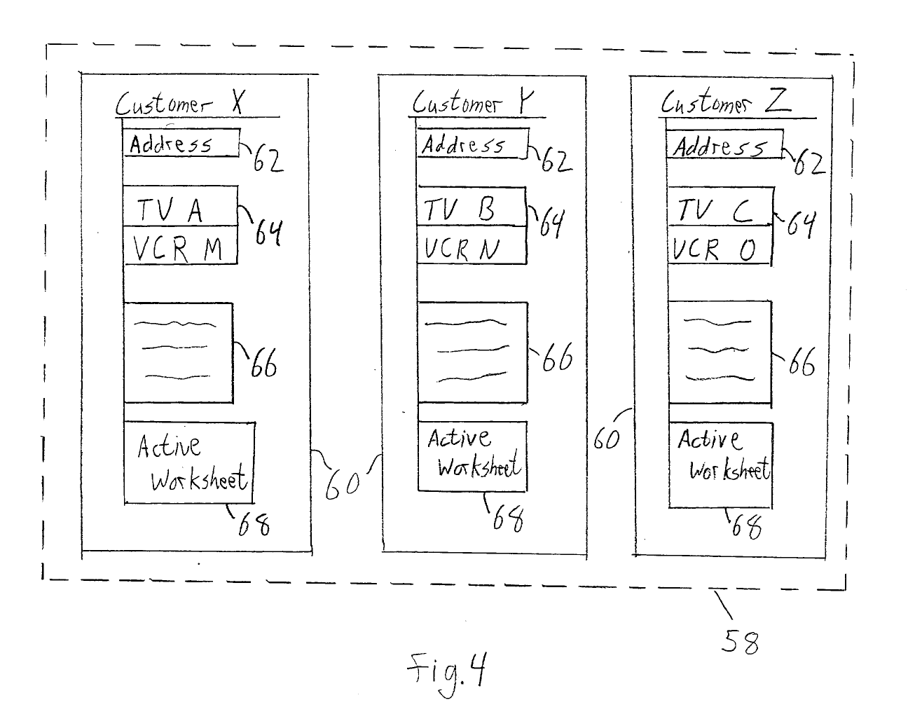

Referring to FIG. 4, the database 14 also includes a customer profile storage area 58. The customer profile storage area 58 includes customer profiles 60 that are developed as sales associates or individual customers utilize the device 10 for purchasing decisions. Customer profiles 60 can initially be developed using known customer information, such as information that is available from a customers associated retail credit card history. In this way, each retail credit card holder's address 62, purchasing history 64, and other informational items 66 can be stored in the customer profile 60 for later access by the device 10 during the purchasing process.

In addition to utilizing previously known information, the customer profiles 60 can be developed using information that is input into the device 10. For example, if a customer wishes to purchase a television, the device 10 can prompt the sales associate to gather information from the customer about specific products 10 in related product categories 56 that the customer already owns. This information can then be used to assure that the specific television purchased by the customer is compatible with the devices already owned by the customer. Similar information can be stored in the customer profile 60 for products and services in substantially any retail area 42. Furthermore, every product and service considered by the customer is stored in an active worksheet area 68 of the customer profile 60 to further assist future purchasing decisions.

The device 10 communicates with the database 14 and is operable to assist a retail sales associate in the presentation, selection, and sale of products and services to a customer. Described below and illustrated in FIGS. 4-10 is a hypothetical customer/sales associate interaction in which the device 10 is utilized by the sales associate to offer appropriate products and services to the customer, while facilitating the selection of specific products and services by the customer. The illustrative example below relates to the purchase of a desktop computer. However, it will be readily understood that the device 10 and database 14 are configured to support the offering and selling of substantially any product or service.

Upon engaging the customer, the sales associate inquires about the type of product or service in which the customer is interested. Upon receiving such information, the sales associate then enters the information into the device 10 using the touch screen or stylus, or the sales associate may scan the bar code of a particular product that generally corresponds to the customer's area of interest using the product scanner 34. In this example, assume that the sales associate scans the bar code of a desktop computer that is on display in the retail store. Upon scanning the bar code, the device 10 transmits the bar code information to the database 14. The database 14 processes the bar code and determines to which retail area 42, product category 46, and specific product 50 the bar code corresponds. The database 14 then generates a product offering list 70 (illustrated in FIG. 4) that generally includes the scanned item as well as similar items located within the same product category 46. As the product offering list 70 is compiled, the database 14 may also perform an inventory check 74 to determine which products 50 in the product offering list 70 are currently in stock.

The completed product offering list 70 is transmitted to the device 10 and displayed to the sales associate and the customer. The product offering list 70 includes information about each product and preferably arranges the product offering list 70 from “low-end” to “high-end” products as indicated by a product barometer bar 78. The arrangement of the list 70 is generally based on product features and cost, however other arrangements the list 70 are possible. The product offering list 70 may also include a picture 82 of the specific product 50 as well as a brief description 86 thereof. In the illustrated list 70, recommended modes of use 90, highlights 94 of the specific product 50, product price 98, and rebate and warranty information 102 are also provided. The product offering list 70 is intended to inform and assist the customer in reaching a decision to buy a specific product 50 and may be configured to provide substantially any information about a product that might assist a customer in reaching a purchasing decision. The product offering list 70 also includes links 106 to the other product categories 46 that are most closely related to the product category 46 of the products 50 in the list 70. With respect to desktop computers, the product offering list 70 may include links 106 that access database 14 information about laptop computers, monitors, printers, and other closely related products based upon the information stored in the related product categories field 56 of the specific product 50 entry.

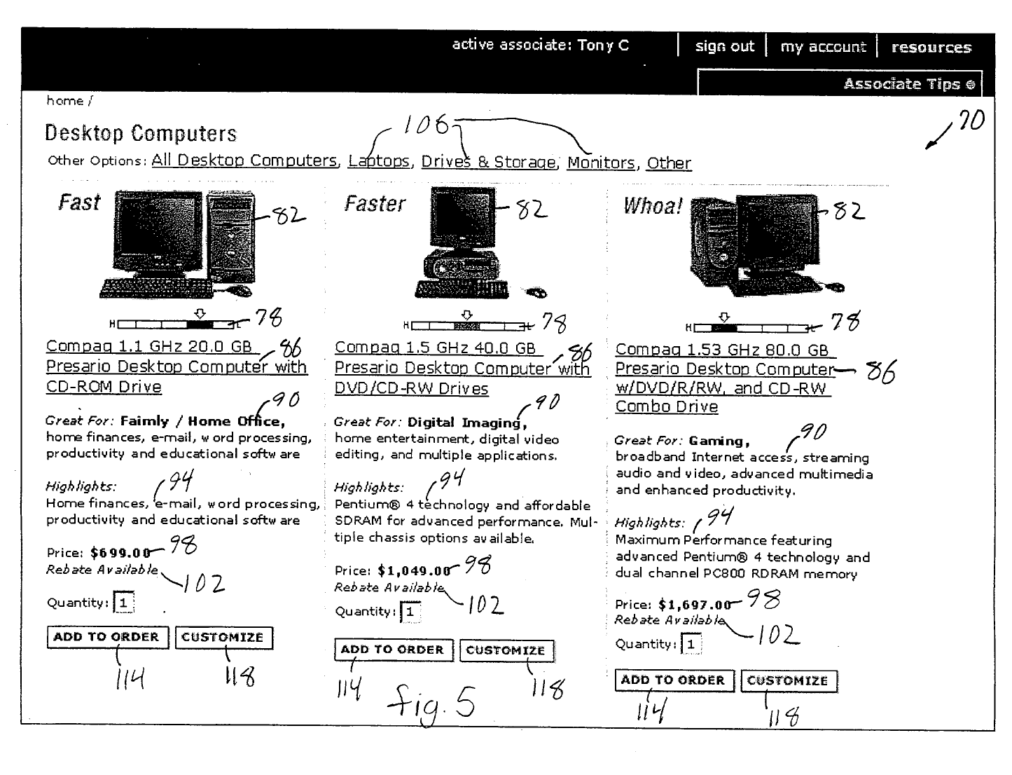

At any time during the product selection process, the sales associate may prompt the device 10 for a customer questionnaire 110 (illustrated in FIG. 5). The device 10 in turn contacts the database 14 which compiles a series of questions 112 that are intended to further guide the customer through the product selection process. The questions 112 are preferably selected by taking into account information that exists in the customer profile 60, and other information that has been previously acquired from the customer. The illustrated questionnaire 110 corresponds to the selection of a desktop computer, per the example presented above. The questions 112 are preferably yes or no questions and are formulated to quickly and simply narrow the specific products that are presented in the product offering list 70. In this respect, the questionnaire 110 may be used to gradually reduce the number of products 50 in the product offering list 70 until such time as the customer is able to decide between the remaining products 50.

To further narrow the products in the product offering list 70 an additional questionnaire can be presented that relates to computer components that the customer may already own. For example, with respect to the home computer example, a customer might already own a home computer and is merely looking to purchase an upgraded computer. As such, the customer may already own a monitor, keyboard, mouse, printer, and other related items. The customer profile 60 can be utilized to gather and store information about the computer related items already owned by the customer, such that the product offering list 70 can be narrowed to items that are compatible with the customers currently owned products.

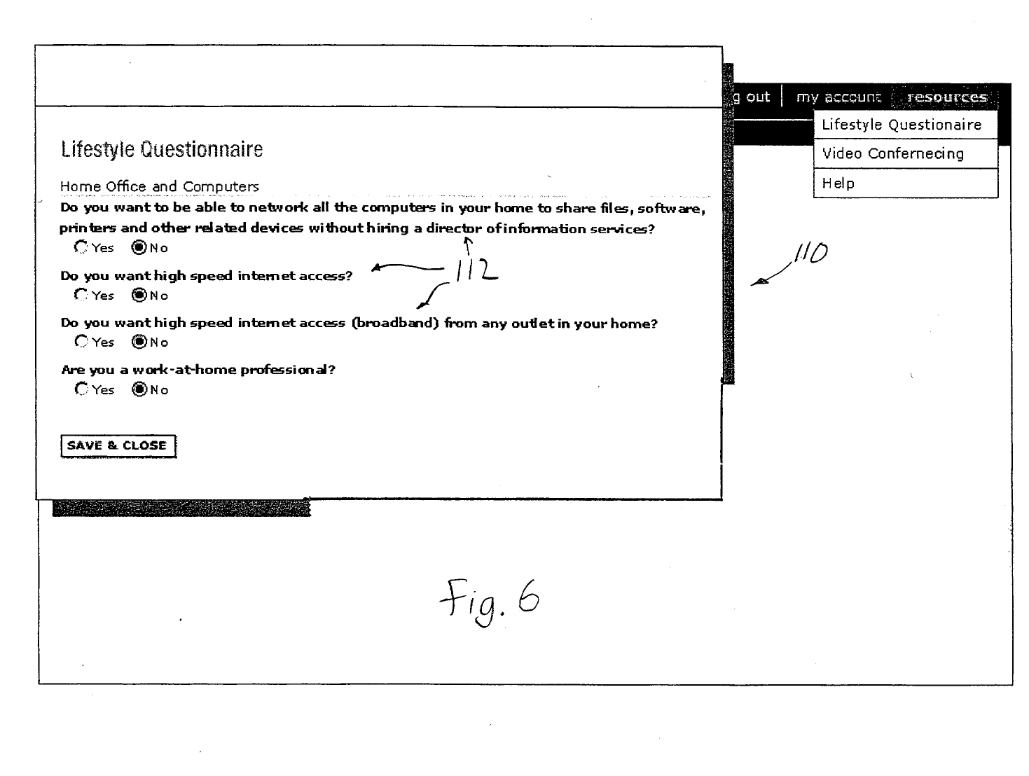

The product offering list 70 also includes a buy button 114, for immediate selection of a specific product 50 for purchase, and a customize button 118 that directs the sales associate to a product customization screen 122 (illustrated in FIG. 6). Thus, in the event that none of the preselected products in the product offering list 70 meet the customers needs, the product customization screen 122 allows the customer to specifically select a desired product configuration. As illustrated, the desktop computer customization screen 122 provides for the selection of specific computer components including the processor, memory, hard drive, CD-ROM drive, and other items. It should be appreciated that different products will have differently configured product customization screens 122 depending upon the relative amount of customization that may be performed upon the specific product 50.

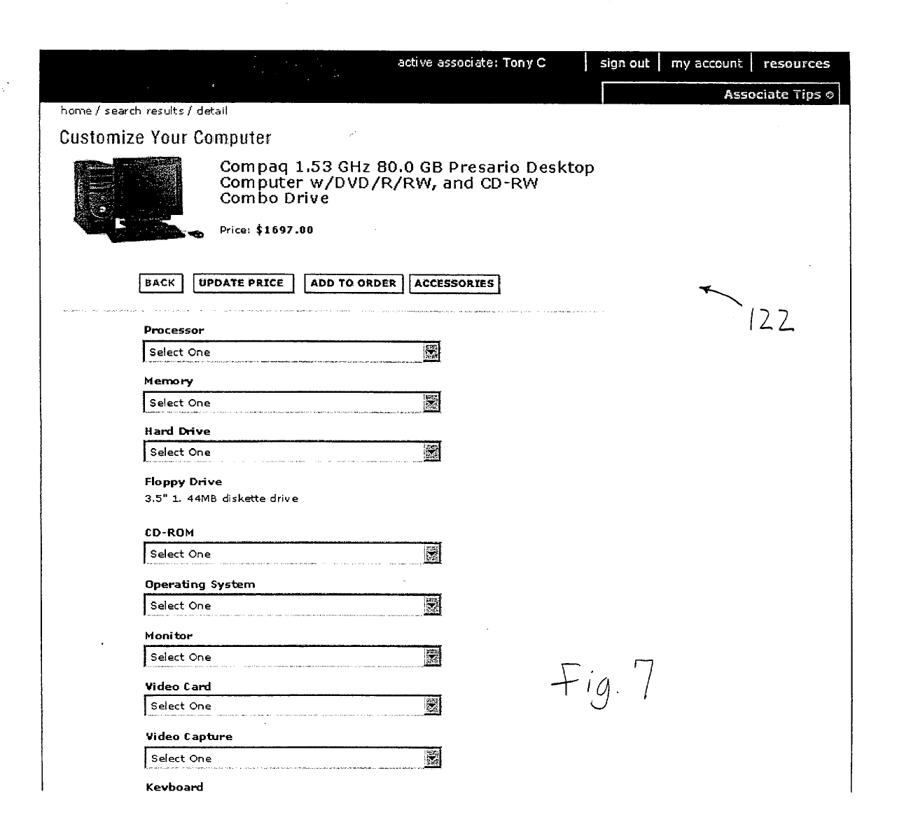

If the customer desires additional information about a specific product 50, the sales associate may prompt the device 10 to display a product specification screen 126 (illustrated in FIG. 7). The product specification screen 126 includes additional information about the product including, for example, operating system and software information 130. The product specification screen 126 also preferably lists sale and rebate information 134 and product inventory status 138. The product specification screen 126 further lists the related service categories 46 for the specific product 50. As illustrated, the related service categories 46 include a selection of service agreements 142 and a selection of Internet connection options 146. It should be appreciated that the specific service agreements 142 and Internet connection options 146 are generally stored in the fourth level 54 of the database 14 in the same manner as the specific products 50. In this respect, the specific services 142, 146 include information fields that are similar to the information fields for the specific products 50. The sales associate may select a specific service and prompt the device 10 to display a service specification screen (similar to the product specification screen 126) that describes the specific service in greater detail. The product specification screen 126 also includes a buy button 114 and a customize button 118 similar to the product offering list 70.

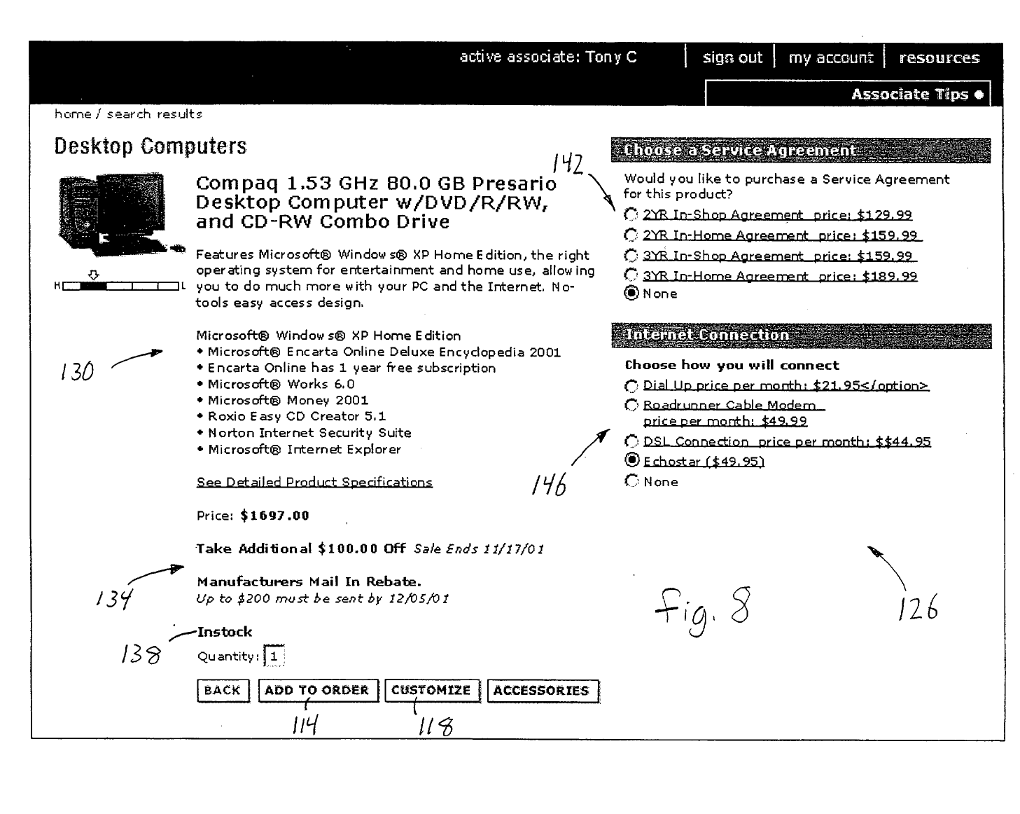

Prior to final selection and ordering of a specific product 50, the device 10 is configured to display a related product selection screen 150 (illustrated in FIG. 8). As discussed above, the database 14 includes a related product categories field 56 that links a specific product with related product categories 46. The products presented by the related product selection screen 150 are generally the same as those found in the related product categories 46. In general, the related product selection screen 150 presents the sales associate and the customer with products that are closely related to the selected specific product 50. In the exemplary illustration, the product categories related to the selected desktop computer include printers, digital video and accessories, digital still cameras, and scanners. Preferably, information from the customer profile 60 is also utilized when selecting products for display in the related product selection screen 150. Selection of any of the related products would once again lead the customer through a product selection process for the related products, similar to the selection process used to select the specific desktop computer in the example above.

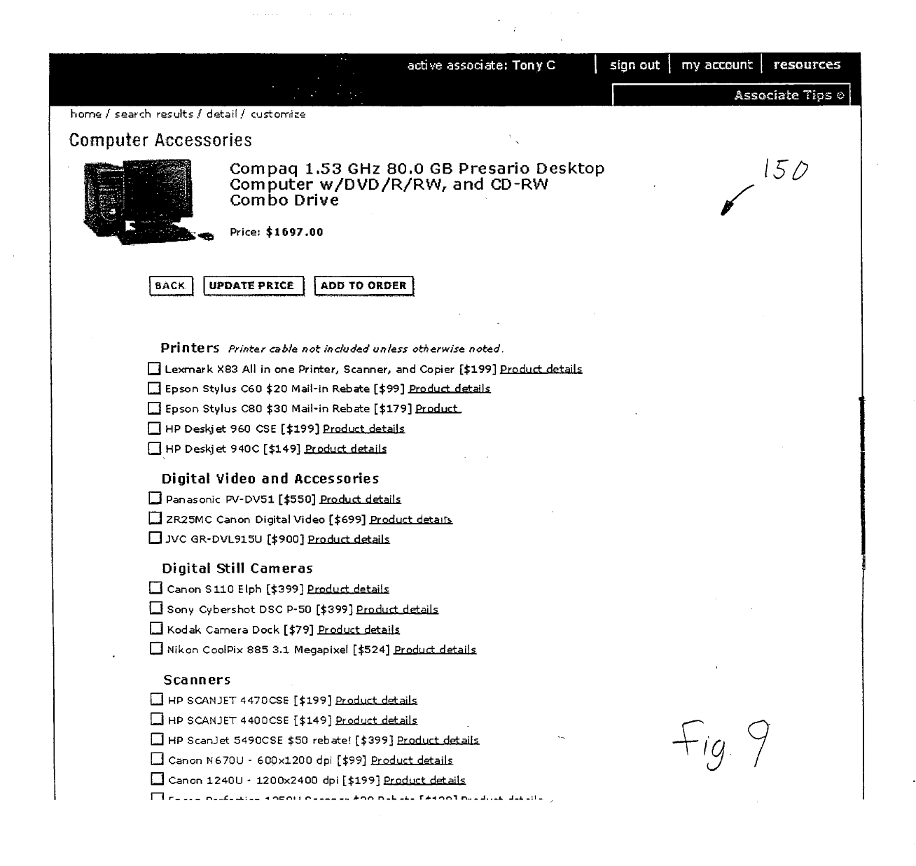

Once a specific product 50 has been selected, and once associated services and related products have been offered and possibly selected, a final upsell screen 154 (illustrated in FIG. 9) is displayed. The final upsell screen 154 prompts the sales associate to ask various questions that relate to additional related products and services that may be beneficial to the customer. The final upsell screen 154 is preferably compiled by the database 14 using information in the customer profile 60, information gathered from the product selection process, as well as information gathered from the questionnaire 110, if applicable. The final upsell screen 154 ensures that each item in the related product categories field 56 and the related services field has been presented to the customer, and may also present additional items that may compliment items already owned by the customer. The illustrated final upsell screen 154 includes prompts and links related to service agreements, wireless home network hardware, additional data storage hardware, CD burning hardware, and a home installation service. As is the case with substantially all of the screens discussed above, the content of the final upsell screen 154 will vary based on the particular products and services that are being sold.

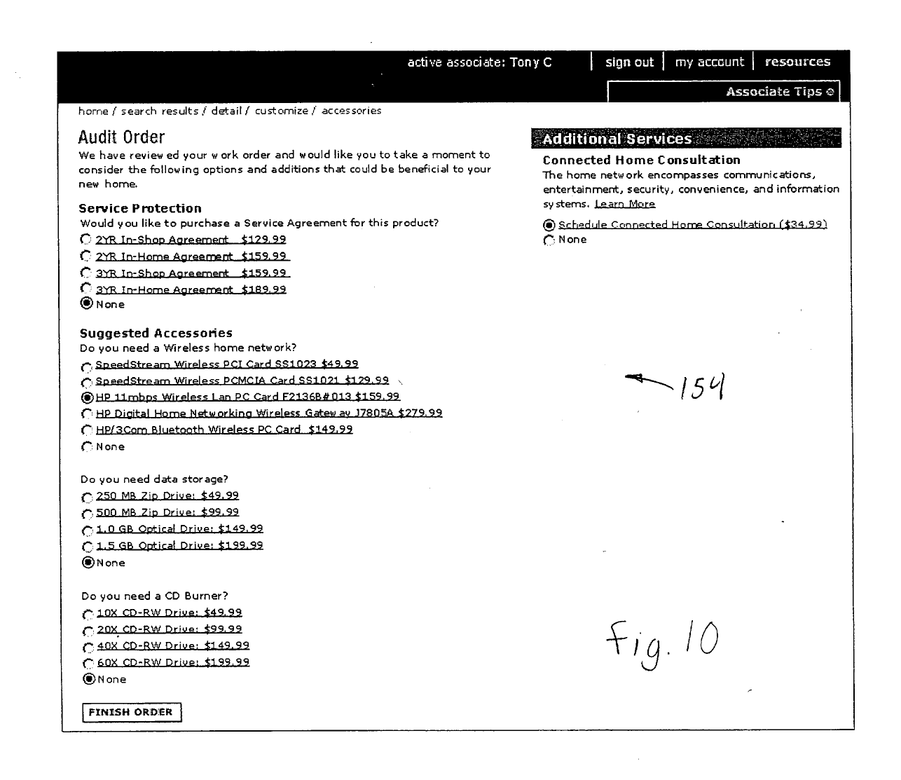

Once all related products and services have been presented to the customer, and once the customer has made all purchasing decisions, all products and services in the active worksheet 68 of the customer profile 60 are permanently stored in the database 14 for use in future purchasing decisions. In addition, a complete order is submitted to the database 14 and a printer (not shown) prints a work order 158 (illustrated in FIG. 10) that lists the purchased products and services. The work order 158 includes bar codes 162 that correspond to the selected products and services and that are readable by a point of sale cash register. In this way, all the products and services selected by the customer are summarized and listed on one form that may be carried to a check-out area and used to facilitate a monetary transaction. The device 10 may also signal a product pick-up location within the retail store so that the selected products may be removed from a storage area and compiled for convenient pick-up by the customer.

The device 10 may also be configured such that the customer's address information may be entered or taken directly from the customer profile 60 and delivery and installation of the products may be arranged. The device 10 also provides a direct link to the various service providers of the related services. For example, if a customer purchases the desktop computer of the above example and also selects a specific type of internet connection, the device 10 and database 14 may contact an appropriate internet service provider and provide the customer information to the service provider, thereby facilitating the commencement and installation of internet service with no further action required by the customer.

A further feature of the device 10 is that at substantially any time during the sales associate/customer interaction, the device 10 may provide a direct link to an expert sales associate that is remotely located, either at a different location within the retail store, or at a different retail store altogether. For example, if the customer has a question that the on-site sales associate is unable to answer, the sales associate may utilize the device to establish a real-time video conference between the customer and the expert sales associate. Thus expert sales associates with exceptional knowledge of a particular field are available to answer the questions of customers in multiple retail locations.

The foregoing description of the present invention has been directed toward an exemplary situation involving the purchase of a desktop computer. It should be appreciated that the device 10 and database 14 are configured for use throughout a variety of retail environments, and the forgoing example should in no way be construed as limiting. As described herein, the device 10 provides a tool and method for allowing sales associates to customize retail purchasing experiences by accessing a database 14 that prompts the sales associate to ask a variety of specific questions. The questions are formulated to assist in determining the most appropriate products, services, and related accessories for fulfilling the customers needs. Information gathered during the product selection process is stored in a customer profile, and may be utilized to further assist future purchasing decisions. The device also includes video-conferencing capabilities to connect the customer with an expert sales associate if necessary.

Various features and advantages of the invention are set forth in the following claims.

What is claimed is:

1. A portable electronic device or an in-store kiosk for use in communicating product data in a commercial environment, the portable electronic device or in-store kiosk comprising:
an electronics module including a communication interface for acquiring product data from a remote product database;
a display device connected to the electronics module; and
software, stored on computer-readable medium accessible by the portable electronic device, that generates a related, alternative or complementary suggestion for a product in response to a specific inquiry about the product, and that displays the suggestion on the display device.

2. The portable electronic device or in-store kiosk of claim 1, wherein the electronics module includes a data input device.

3. The portable electronic device or in-store kiosk of claim 2, wherein the data input device is a bar code scanner.

4. The portable electronic device or in-store kiosk of claim 2, wherein the data input device is a touch screen.

5. The portable electronic device or in-store kiosk of claim 4, wherein the touch screen is integrated with the display device connected to the electronics module.

6. The portable electronic device or in-store kiosk of claim 1, wherein the related, alternative, or complementary suggestion for a product includes an extended warranty plan.

7. The portable electronic device or in-store kiosk of claim 1, wherein the related, alternative, or complementary suggestion for a product includes an accessory for the product.

8. The portable electronic device or in-store kiosk of claim 1 further comprising software that generates customer characteristics for a customer based on the purchasing history of the customer stored in a remote database.

9. A portable electronic device or an in-store kiosk for use in communicating product data in a commercial environment, the portable electronic device or in-store kiosk comprising:
an electronics module including a communication interface for acquiring product data from a remote product database;
a display device connected to the electronics module; and
means for generating a related, alternative or complementary suggestion for a product in response to a specific inquiry about the product, and for displaying the suggestion on the display device.

10. The portable electronic device or in-store kiosk of claim 9, wherein the electronics module includes a data input device.

11. The portable electronic device or in-store kiosk of claim 10, wherein the data input device is a bar code scanner.

12. The portable electronic device or in-store kiosk of claim 10, wherein the data input device is a touch screen.

13. The portable electronic device or in-store kiosk of claim 12, wherein the touch screen is integrated with the display device connected to the electronics module.

14. The portable electronic device or in-store kiosk of claim 9, wherein the related, alternative, or complementary suggestion for a product includes an extended warranty plan.

15. The portable electronic device or in-store kiosk of claim 9, wherein the related, alternative, or complementary suggestion for a product includes an accessory for the product.

16. The portable electronic device or in-store kiosk of claim 9 further comprising means for generating customer characteristics for a customer based on the purchasing history of the customer stored in a remote database.

17. A method of offering alternative or complementary product suggestions in response to an inquiry about the product, the method comprising the acts of:
providing a portable electronic device or in-store kiosk including an electronics module having a communication interface for acquiring product data from a remote product database, and having a display device connected to the electronics module;
prompting the portable electronic device or in-store kiosk to communicate with the remote product database to gather information about a specific product; and
generating in response to the prompt information on related, alternative, or complementary products and displaying the information on the display device.

18. The method of claim 17 further comprising obtaining customer-specific information from a customer to prompt the portable electronic device or in-store kiosk to gather information about specific products of interest to the customer.

19. The method of claim 17, wherein providing a portable electronic device or in-store kiosk including an electronics module includes providing a data input device.

20. The method of claim 19, wherein providing a data input device includes providing a bar code scanner.

21. The method of claim 19, wherein providing a data input device includes providing a touch screen.

22. The method of claim 17 further comprising generating customer characteristics for a customer based on a purchasing history of the customer stored in a remote database.

23. An electronic device for use in communicating product data in a commercial environment, the electronic device comprising:
an electronics module including a communication interface for acquiring product data from a remote product database;
a display device connected to the electronics module; and
software, stored on computer readable medium accessible by the portable electronic device, for effecting audio/visual communication between a user of the device and an expert having information about the product.

24. The electronic device of claim 23, wherein the electronics module includes a data input device.

25. The electronic device of claim 24, wherein the data input device is a bar code scanner.

26. The electronic device of claim 24, wherein the data input device is a touch screen.

27. The electronic device of claim 26, wherein the touch screen is integrated with the display device connected to the electronics module.

28. The electronic device of claim 23 further comprising software that generates customer characteristics for a customer based on the purchasing history of the customer stored in a remote database.

29. The electronic device of claim 23, wherein the audio/visual communication between a user of the device and an expert occurs in real time.

30. An electronic device for use in communicating product data in a commercial environment, the electronic device comprising:
an electronics module including a communication interface for acquiring product data from a remote product database;
a display device connected to the electronics module; and
means for effecting audio/visual communication between a user of the device and an expert having information about the product.

31. The electronic device of claim 30, wherein the electronics module includes a data input device.

32. The electronic device of claim 31, wherein the data input device is a bar code scanner.

33. The electronic device of claim 31, wherein the data input device is a touch screen.

34. The electronic device of claim 33, wherein the touch screen is integrated with the display device connected to the electronics module.

35. The electronic device of claim 30 further comprising software that generates customer characteristics for a customer based on the purchasing history of the customer stored in a remote database.

36. The electronic device of claim 30, wherein the audio/visual communication between a user of the device and an expert occurs in real time.

37. A method of providing product information from a remote product expert to a customer in a commercial environment, the method comprising the acts of:
providing an electronic device including an electronics module having a communication interface for acquiring real time video and audio data representing the image and voice of the product expert, having a display device connected to the electronics module for generating images based on the video data, and having a speaker for generating sounds based on the audio data;
prompting the electronic device to communicate with the remote product expert; and
transmitting the video and audio data to the electronic device; and
generating the image and voice sounds of the remote product expert on the display device and the speaker, respectively.

38. The method of claim 37, wherein prompting the electronic device includes obtaining and entering customer-specific information from a customer relating to products of interest to the customer to ensure the electronic device communicates with the appropriate remote product expert.
